(19) United States
(12) Patent Application Publication
(10) Pub. No.: US 2006/0236925 A1
(43) Pub. Date: Oct. 26, 2006

(54) Modular seed treatment apparatus

(76) Inventor: Virgil D. Lund, Eden Prairie, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/338,436

(22) Filed: Jan. 24, 2006

Related U.S. Application Data
(60) Provisional application No. 60/646,781, filed on Jan. 24, 2005.

(51) Int. Cl. A23G 3/26; B05C 3/00

(52) U.S. Cl. 118/19; 118/29

(57) ABSTRACT

The apparatus of the invention is directed toward a modular seed treatment apparatus that is capable of receiving various component pieces of equipment for application of liquid treatment compositions and powders to seeds on a frame assembly to accommodate the various component pieces. The apparatus of the invention is further directed toward a modular seed treatment apparatus that is capable of receiving a treatment container for treatment of various small quantities of seed including 0.5 to two pounds, two to five pounds and 5 to 10 pounds of seed.

### CROSS REFERENCE TO RELATED APPLICATIONS

The current applications claims the benefit of priority from U.S. provisional patent application filed on Jan. 24, 2005, entitled “Modular Seed Treatment Apparatus,” having Ser. No. 60/646,781, which is incorporated herein by reference.

### FIELD OF THE INVENTION

The present invention relates to an apparatus for surface treatment of seeds built in a modular fashion to accommodate the varying needs of the user by allowing for addition, removal or substitution of components and to an improved treatment container.

### BACKGROUND OF THE INVENTION

Seeds that are planted for agricultural and other purposes are often treated prior to planting. The treatments may accomplish many different purposes including deterrence or prevention of insect and other animal pests that would target sown or newly germinated seed for attack. These animals may directly cause damage to the seed or may introduce one or more pathogens, including viruses, directly into the seed. Treatments may also target bacteria, molds and fungus that have contaminated seeds or that are known to be present in the soil in which the seeds will be planted. Direct application of seed treatment allows for a reduction in the amount of treatment composition that would be required by application to soil after planting. Also, post-planting application may not penetrate the soil to a level or location where it would be effective.

Treatment of seeds, however, involves applications of chemicals and other agents that are expensive and may even be toxic to the seeds on which they are applied. The amount of treatment composition is also necessarily small and often provides protection or other advantage for only a short period of time after planting. However, in a number of situations, the advantages of treatment with one or more compositions will outweigh the disadvantages. These situations include the use of rare or expensive seed, the use of older seed or seed with low germination rates, the use of seed known to be contaminated or infested, the use of seed known to have been produced in conditions likely to lead to contamination or infestation, and the use of seed in fields known to be prone to contamination or infestation.

Various devices for treatment of seeds in batch or continuous treatment mode are known. U.S. Pat. No. 5,891,246 to Lund, the disclosure of which is hereby incorporated by reference, commonly assigned with this application to Gustafson, Inc. describes a seed coating apparatus for applying a coating fluid whereby seeds are dispersed with a seed dispersing member.

U.S. Pat. No. 4,657,773 to Mueller, the disclosure of which is hereby incorporated by reference, describes a process and apparatus for dressing seed in which seed is guided over a dispensing cone through a jet of dressing and onto a rotary table.

DE 4411058 to Niklas, the disclosure of which is hereby incorporated by reference, describes a device with a mixing bowl connected to a high speed, multi-turn actuator and a mechanism to feed seed into the mixing bowl. The bowl rotates to rotate seed being treated therein. The seed treating formulation is sprayed in the bowl while the seed is being rotated to uniformly coat the seed with the formulation.

### SUMMARY OF THE INVENTION

The apparatus of the invention is directed toward a modular seed treatment apparatus that is capable of receiving various component pieces of equipment for application of liquid treatment compositions and powders to seeds on a frame having lower frame and upper frame components to accommodate the various component pieces. The apparatus may have a pre-mix container for blending and dispensing treatment composition, an interchangeable treatment container wherein seed is blended with treatment composition, a pump for dispensing treatment composition from the pre-mix container to the treatment container, flow control mechanisms to introduce seed into the treatment container for treatment and out of and away from the treatment container after treatment. The apparatus may have a storage hopper for holding untreated seed and a scale interposed between the untreated seed hopper and the interchangeable treatment container for identifying and dispensing batches of seed for treatment. The apparatus may also have a powder storage container and powder conveyor for introducing powders into the treatment container in addition to treatment compositions.

The apparatus of the invention is further directed toward a modular seed treatment apparatus that is capable of receiving a treatment container for treatment of various small quantities of seed including 0.5 to two pounds, two to five pounds and 5 to 10 pounds of seed.

The apparatus of the invention is further directed toward a modular seed treatment apparatus in which the lid of the treatment container is flat and optionally is constructed from transparent material. The lid has one or more (and usually three or four) fins reversibly attached to the underside of the lid. The fins are reversibly attached to the lid and may be varied in configuration according to the seed being treated. The spacing of the fins on the lid may also be varied to ensure maximum interaction of seed in the treatment container with the treatment composition and with any powder introduced therein.

In one aspect, the invention relates to a modular seed treatment apparatus for applying fluids to seeds comprising a frame assembly, a storage hopper mounted to the frame assembly comprising a plurality of side walls operably coupled to define an interior space adapted to store untreated seeds and at least one pre-mix container mounted to the frame assembly, the pre-mix container defining an interior storage region adapted to store a seed treatment fluid. In these embodiments, the apparatus can further comprise an interchangeable treatment container mounted to the frame assembly comprising a body portion, a rotating bowl disposed within the body portion and a lid portion comprising a plurality of fins for directing seeds downwards and towards the center of the rotating bowl, the lid portion being reversibly secured to the body portion, wherein the interchangeable treatment container is operably coupled to the hopper to receive untreated seeds and to the pre-mix container to receive seed treatment fluid, and wherein the interchangeable treatment container can be removed from the frame assembly without disengaging the storage hopper assembly or pre-mix container from the frame assembly.

In another aspect, the invention relates to a method of applying fluid to a seed comprising operably coupling an interchangeable treatment container to a pre-mix container and to storage hopper assembly. In these embodiments, the interchangeable treatment container can comprise a body portion, a rotating bowl disposed within the body portion and a lid portion comprising a plurality of fins for directing seeds downwards and towards the center of the rotating bowl, the lid portion being reversibly secured to the body portion, wherein the pre-mix container and the storage hopper assembly are mounted to a frame assembly, and wherein the interchangeable treatment container can be coupled and uncoupled from the pre-mix container and the storage hopper assembly without disengaging the storage hopper assembly or the pre-mix container from the frame assembly.

### BRIEF DESCRIPTION OF THE DRAWINGS

FIG. 1 is a perspective view of an embodiment of a modular seed treatment apparatus according to the present invention.

FIG. 2 is an exploded view of an embodiment of a modular seed treatment apparatus according to the present invention. Although only one treatment container is normally employed during operation of the apparatus, three interchangeable treatment containers adapted to treat different sized batches of seed are shown.

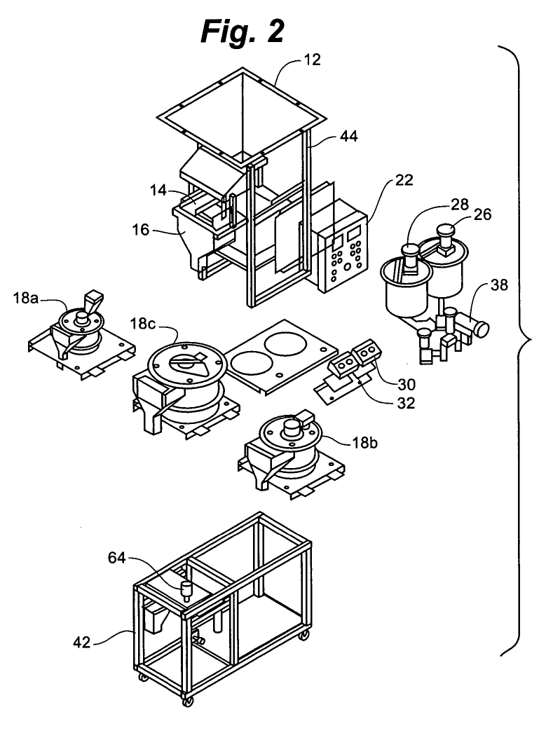

FIG. 3 is an exploded view of the upper part of the frame of the apparatus without the control panel in view.

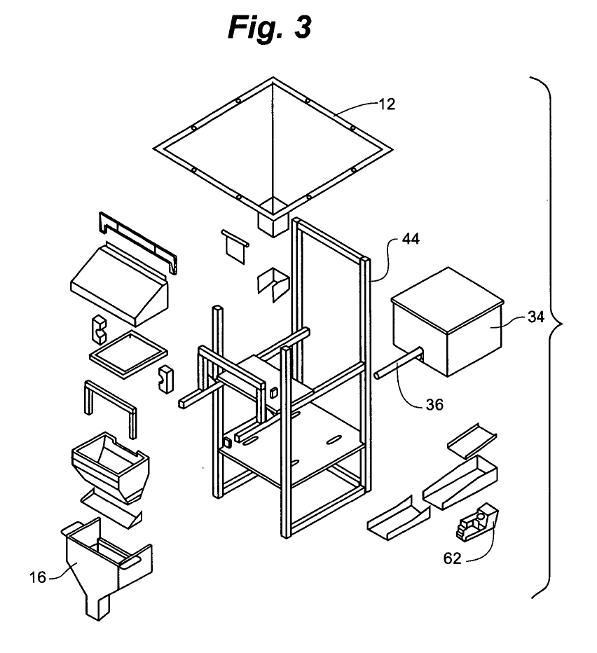

FIG. 4 is an exploded view of a treatment container adapted for treatment of batches that are eight ounces to two pounds.

FIG. 5 is an exploded view of a treatment container adapted for treatment of batches that are two pounds to five pounds.

FIG. 6 is an exploded view of a treatment container adapted for treatment of batches that are five pounds to ten pounds.

FIG. 7 is a top perspective close-up view of a treatment container according to the present invention.

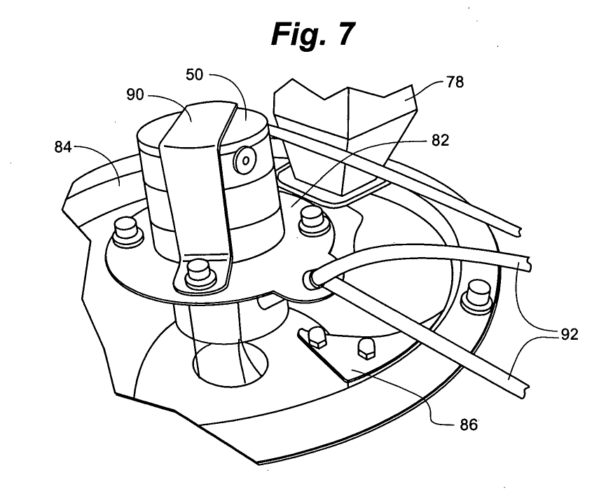

FIG. 8 is a perspective view of a lid for a treatment container inverted for viewing of the fins reversibly attached to the lid.

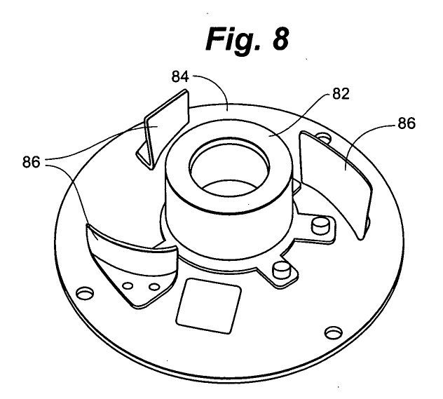

FIG. 9 is a close up view of a fin in place in a treatment container and visible through the clear portion of the lid.

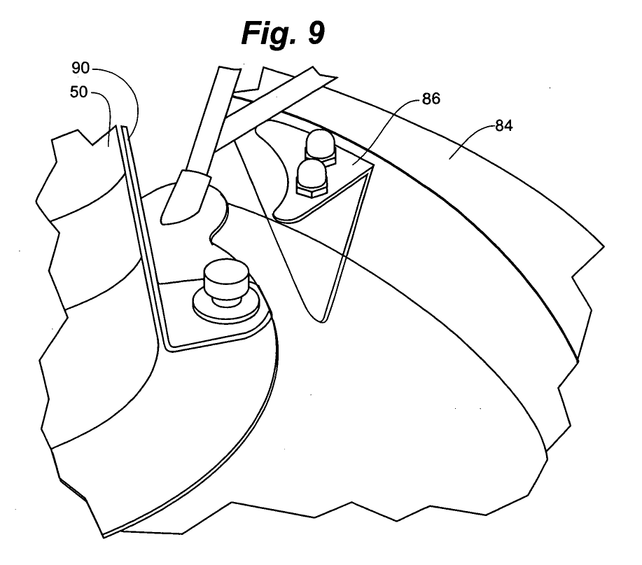

FIG. 10 is a top perspective view of a lid of a treatment container with a portion of the atomizer visible after removal from its installed position in the lid.

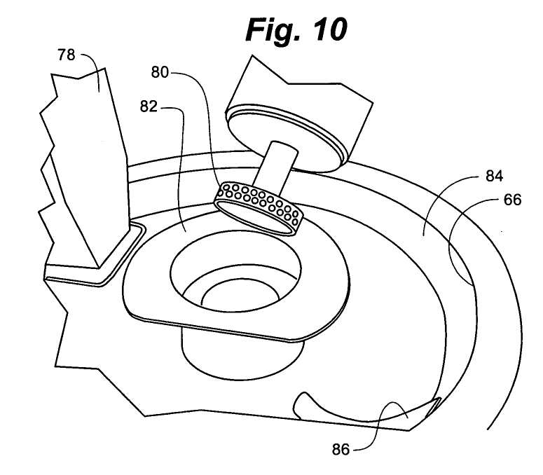

FIG. 11 is a side perspective view of a treatment container showing pneumatic control lines for operation of the exit door of the treatment container.

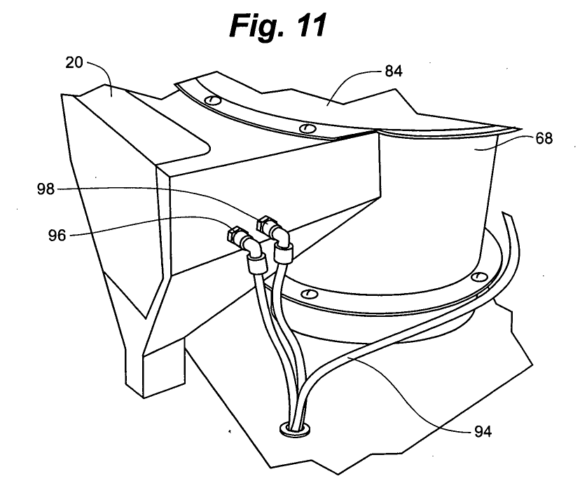

FIG. 12 is a side view of a portion of the treatment composition blend and dispense system.

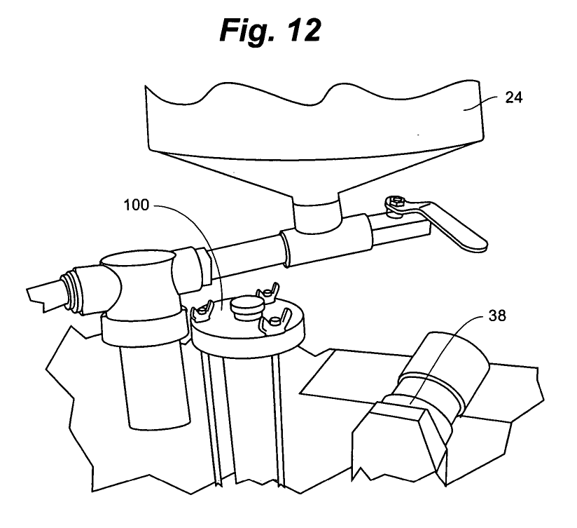

FIG. 13 is a side view of a portion of the treatment composition blend and dispense system.

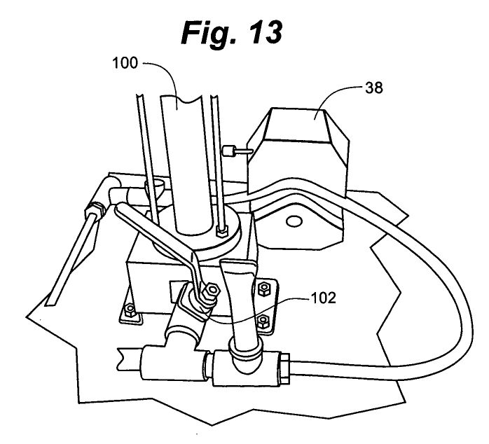

FIG. 14 is a top perspective view of a pre-mix container with the top removed from its installed position, but with agitator paddles still visible.

FIG. 15 is a front view of a controller for a treatment apparatus according to the present invention with controls turned off.

FIG. 16 is a front view of a controller for a treatment apparatus according to the present invention with the controls ready to treat seed with liquid to be dispensed from Pump 1, but not Pump 2, and with no powder dispensed as part of the treatment.

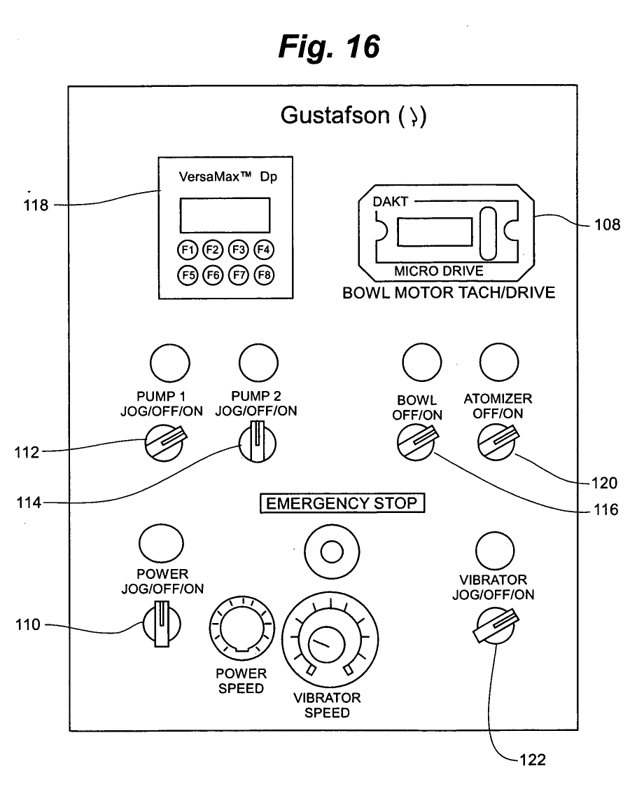

### DETAILED DESCRIPTION OF THE INVENTION

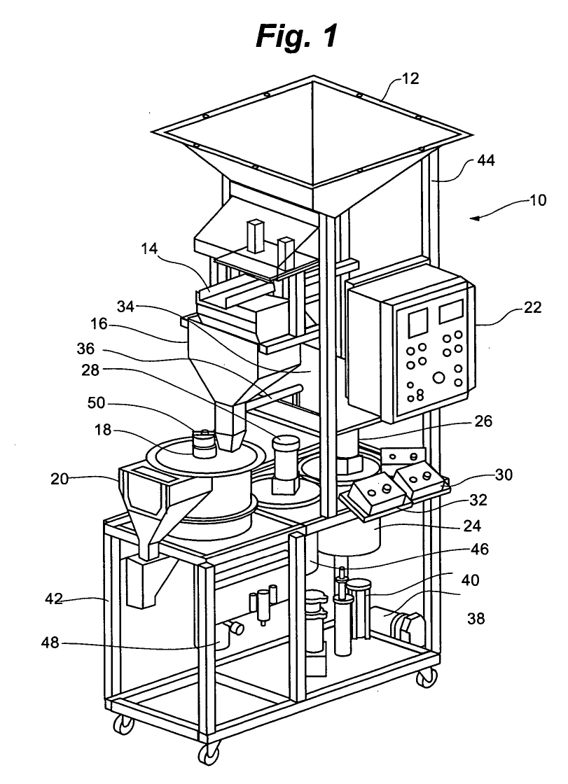

A modular seed treatment apparatus according to the present invention may be assembled onto a frame assembly having an upper frame component and a lower frame component. FIG. 1 shows an apparatus according to the present invention with an untreated seed hopper (12), scale (14), controller (22), conveyance hopper (16), and powder storage container (34) reversibly mounted on upper frame component (44). Powder storage container (34) is in communication with conveyance hopper (16) by means of powder conveyance device (36). Treatment container (18) along with discharge hopper (20), pre-mix containers (24, 46), metering pump motor controllers (30, 32), pumps (38, 60) and bowl motor (48) are mounted to lower frame component (42).

Seed for treatment may be introduced into untreated seed hopper (12) which is mounted at the top of upper frame component (44). Seed contained therein may be dispensed to a scale (14) for weighing and identification of a batch for treatment. Scale (14) may be a manual scale and fed by means of a magnetic or vibratory feeder (62) from untreated seed hopper (12) to scale (14). In the alternative, a load cell may be employed to identify and dispense a batch for treatment. Feeder (62) is directed by controller (22) to operate until such time as scale (14) indicates to controller (22) that the desired weight has been reached. At this point, feeder (62) is stopped and the batch dispensed to conveyance hopper (16).

Conveyance hopper (16) operates to collect the batch identified for treatment and directs the batch to treatment container (18). Conveyance hopper (16) may also define an opening in communication with powder conveying device (36). Powder conveying device (36) communicates with powder storage device (34) to convey powdered ingredients from powder storage device (34) to the interior of conveyance hopper (16). Conveyance hopper (16) may be directly connected to treatment container (18) or may be connected to an additional chute (78) which in turn communicates directly with treatment container (18). Powder storage device (34) is mounted on upper frame component (44) and is controlled, at least in part, by controller (22). Dry feeding devices capable of dispensing powders and other dry materials to be applied to seeds using the present invention are known. Typically, these dry feeding devices will comprise a bin, a hopper or other holding container for the dry material and a port capable of directing the dry material to a desired location through means of an auger, or ribbon flighted rod. The dry material can be conveyed to the interior of conveyance hopper (16) and thereby dispensed to the interior of treatment container (18) at any time during the treatment of a batch, though often the powder or dry material will require the seed to be treated with a wetting agent to promote adherence of the powder or dry material. A drying agent, such as talc, may be added at the end of the treatment process immediately before the seed is allowed to exit treatment container (18). Other dry materials that may be added can include lubricants (such as graphite), dye or coloring agent to signify that seed has been treated, and micronutrients.

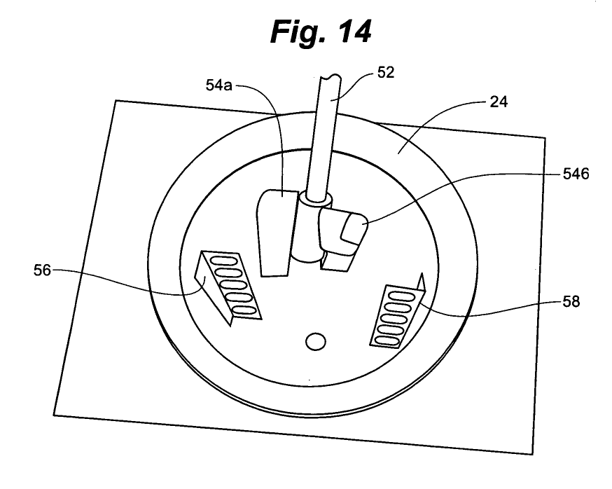

Treatment agents for use in the modular seed treatment apparatus of the invention may be prepared in one or more pre-mix containers, which can be reversibly mounted to the frame assembly. The pre-mix containers (24, 46) may each hold up to ten gallons of solution. As seen in FIG. 14, pre-mix containers (24, 46) may have agitation devices associated with them such as a motor (26, 28) deploying a rod (52) with two or more paddles (54a, 54b) for agitation of liquid contained therein. Additionally, fins (56, 58), optionally defining on or more holes therethrough, may be mounted or molded into the interior sides of the pre-mix container to facilitate creation of additional turbulence thereby assuring more complete mixing of the treatment composition.

Treatment compositions may include bactericides such as streptomycin; fungicides such as captan, carboxin, difenoconazole, fludioxonil, imazalil, mefenoxam, petachlorobitrobenzene, tebuconazole, thiabendazole, thiram, triadimenol; insecticides such as chlorpyriphos, diazinon, imidacloprid, lindane, permethrin, cyfluthrin, thiamethoxam, and combinations thereof. Treatment compositions may be prepared by dissolution of dried powders into a liquid carrier such as water, by preparation of a slurry or emulsion, or by dilution of concentrated preparations of the treatment material into a diluent such as water. Coloring agents or dyes may be made part of the treatment composition. Polymeric and coating additives may also be made part of the treatment composition.

Water or other liquid carrier for treatment compositions need not be sterile, but care should be taken in preparation and maintenance of the pre-mix containers and the fluid communication with treatment containers to prevent introduction of contaminants or allowing non-problematic amounts of contaminants to reproduce to numbers and potency that may have deleterious consequences on treated seed. Treatment composition is conveyed from pre-mix containers (24, 46) to treatment container (18) by a pump (38, 60), such as a peristaltic pump, that does not require interaction of treatment composition with any parts of the pump. Delivery of precise amounts of treatment composition may be accomplished through use of a closed cylindrical container to calibrate the amount of time needed to operate pumps (38, 60) to convey the desired amount of treatment composition. During calibration, at least one valve is closed preventing flow of treatment composition to treatment container (18), and redirecting the flow into the pre-mix container. Another valve is moved to an open position allowing treatment composition to enter the cylinder. The pump is engaged and the rate of flow into the cylinder can be calculated. This rate can then be used to calculate the time that will be required for the pump to dispense the desired amount of treatment composition. After calibration, the valves are changed, emptying the cylinder back into the pre-mix container. The valve to the calibration cylinder can then be closed, and the other valves can be reopened, allowing fluid communication between the pre-mix containers (24, 46) and treatment container (18). Other components may be introduced in line between the pre-mix containers and treatment container (18) including, but not limited to, compensation devices that smooth out the flow from a peristaltic pump thereby preventing spurts of chemical into treatment container (18) and accomplishing production of a uniform atomized spray, filters and other device for removal of solid components from the treatment composition.

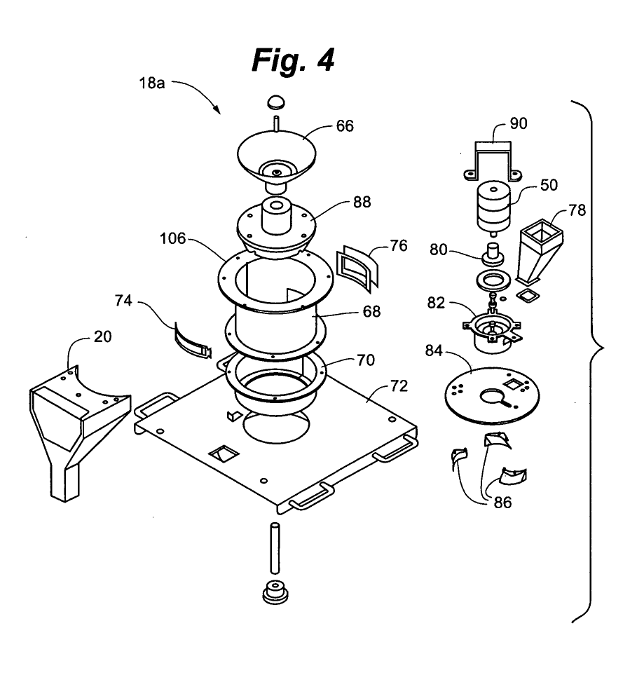

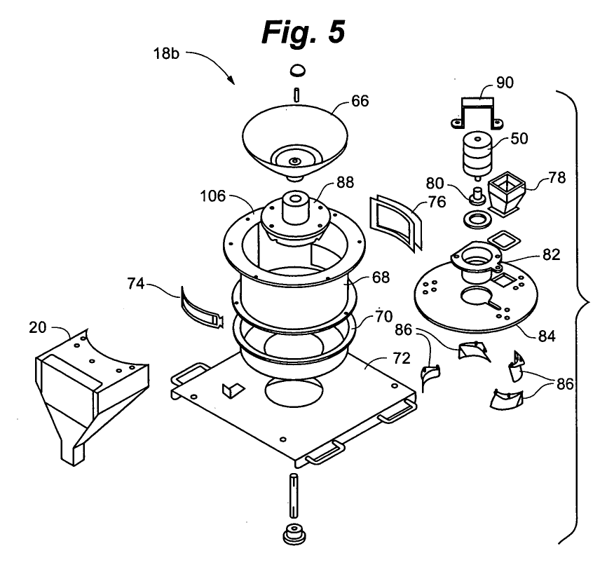

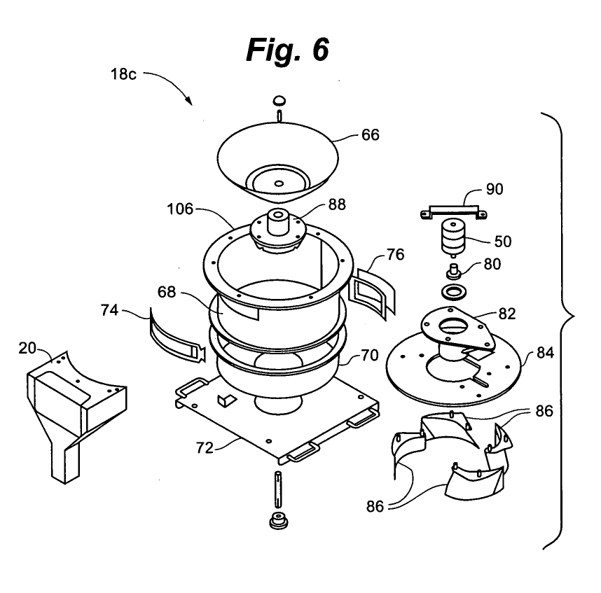

Interchangeable treatment container (18a, as shown in FIG. 4, 18b, as shown in FIG. 5 and 18c, as shown in FIG. 6) is reversibly mounted to lower frame component (42) by means of base (72). Collar (70) is a hollow cylinder with an inward directed flange located at the bottom of the collar and is mounted on base (72). Collar (70) is mounted to body (68). Body (68), along with collar (70), base (72) and lid (84) define a treatment space within treatment container (18).

Lid (84) is reversibly secured to upper flange (106) of body (68) by ordinary mechanical connection including, but not limited to, bolts extending through upper flange (106) and lid (84) or by clamps contacting and applying pressure to outer surfaces of upper flange (106) and lid (84). Lid (84) defines a central opening to accept atomizer base (82) in which atomizer (80) may revolve at high speed to disperse treatment composition. Atomizer (80) is driven by atomizer motor (50) which is reversibly secured in atomizer base (82) by clamp (90). Lid (84) also defines one or more holes for traverse of fluid communication lines (92) therethrough. Fins (86) are reversibly secured to lid (84) and within the treatment space treatment container (18). Fins (86) are designed to direct seeds in contact with the inner surface of the upper sides of treatment container (18) away from the upper sides and toward atomizer base (82) in the center of treatment container (18). Fins (86) may further be designed to deflect seeds coming into contact therewith downward toward bowl (66). Fins (86) may also be designed to deflect seed from the upper inside surface of treatment container (18) into the center toward atomizer base (82) and simultaneously downward toward bowl (66). Fins (86) may be shaped in an inverse plowshare configuration to accomplish the center and downward deflection of seeds being treated. Fins (86) may be positioned on lid (84) in symmetrical patterns, including being placed equidistant from each other. Fins (86) may also be advantageously positioned in irregular distances from each other on lid (84). However, despite their spacing fins (86) will be positioned in contact with the upper sides of treatment container (18) or a minimal distance therefrom to prevent damage to seed being treated within treatment container (18). Configuration of the surface of fins (86) that contacts seed being treated may be adapted to accommodate the various sizes and weights of the seed. Grains that pick up more centrifugal force through contact with rotating bowl (66) may be directed back toward bowl (66) by a sharper angle ensuring seeds do not impact atomizer base (82).

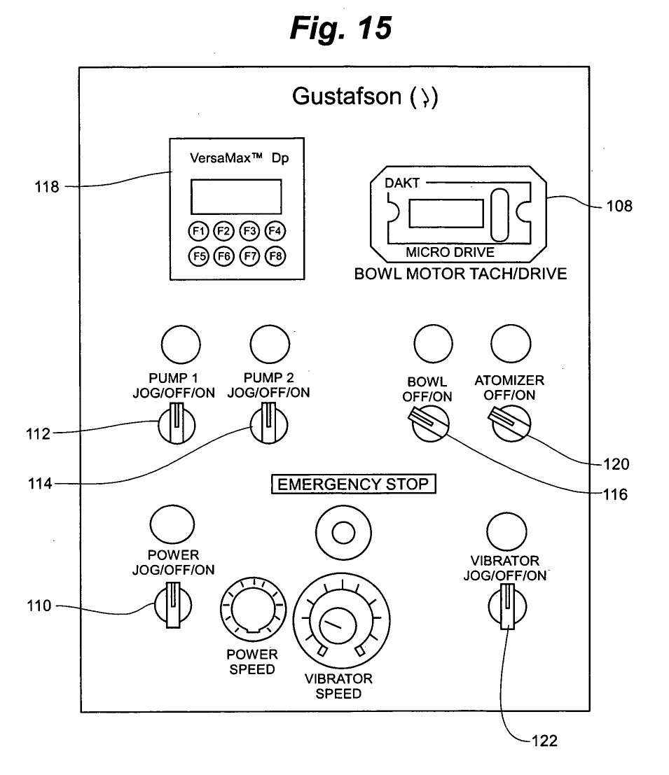

Bowl (66) is disposed within treatment container (18) above bowl base (88) and is driven by bowl motor (48) to rotate in a horizontal plane. Bowl motor (48) and bowl (66) may communicate, for example, by interface (64). In one embodiment, Bowl (66) has a substantially or completely flat surface at and near the center of rotation and angles upward from the substantially planar or planar surface as it approaches the inside wall of treatment container (18). Bowl motor (48) is set to operate at speeds for sufficient to impart centrifugal force to seeds being treated to drive the seeds toward the wall and upward toward fins (86). Forcing the seeds through this path of travel accomplishes mixing that applies treatment compositions over the surface of the seed. Operating speeds for bowl motor (48) may be set and maintained using bowl motor power switch (116) and bowl motor speed controller (108) on controller (22) as shown in FIG. 15. Bowl speeds and configuration including angle of inclination of bowl toward the interior surface of treatment container (18) may be varied in accordance with seed morphology and weight. The object of the variation of motor speed and bowl configuration would be to ensure thorough mixing of seed and treatment composition and/or powder during treatment by causing the maximum amount of seed to make a complete cycle from bowl (66) to inner sides of treatment container (18), across lid (84) and over the seed contacting surface of fins (86).

In operation, an operator will select the components to be utilized in treatment of seeds with the apparatus (10). As will have been evident from the descriptions above, various combinations of equipment may be utilized. In one mode of operation, an operator may place a quantity of seed to be separated into batches and treated in place in untreated seed hopper (12). Seed is dispensed by operation of vibratory feeder (62) into scale (14). Where scale (14) is a manual scale, the amount to be dispensed for each batch can be calibrated prior to operation of the apparatus (10). Pre-mix container (24) is charged with ingredients for the treatment composition and agitator motor (26) is engaged to mix and maintain composition of the treatment composition. A second treatment composition may be prepared by charging a second pre-mix container (46) with ingredients for the second treatment composition and engaging agitator motor (28) to mix and maintain composition of the second treatment composition. Pump distribution of treatment composition may be calibrated, for example, using closed calibration cylinder (100) access to which may be controlled by valve (102). Powder container (34) may also be charged with dry powder or a mixture thereof. The dry powder may be talc that is introduced after completion of the treatment with first and optional second treatment composition to act as a drying agent. Powder conveyer (36) is operated manually by operation of powder conveyer switch (110) on controller (22) to advance powder to conveyance hopper (16). Pump 1 switch (112) and optionally Pump 2 switch (114) are moved to the “ON” position enabling controller (22) to operate one or both pumps in accordance with the programs entered into the controller. Programs may be selected, entered or modified using program controller (118). It will be understood that operations instructions may also be given to controller (22) from programs being run on remote computers. Powder distribution switch (110) is then optionally moved to “ON” position also allowing controller (22) to operate the powder conveyor in accordance with program instructions. Atomizer power switch (120) is also moved to the “ON” position. Separately, air compressor switch (not shown) controlling air compressor (not shown) that operates seed exit door (74) and provides positive pressure to the treatment space underneath bowl (66) preventing collection of dust, treatment composition and broken seed particles is moved to “ON” position. Once these switches have been engaged, power switch (122) for feeder (62) is moved to “ON” position allowing for operation of system and execution of programs stored with controller (22).

Predetermined quantities of seed are then dispensed by scale (14) to conveyance hopper (16). Seed falls into treatment container (18) and falls into bowl. Rotation of bowl (66) causes seed to be urged to the outside of the bowl and against the inner side of treatment container (18) as well as upward toward lid (84). Fins (86) direct seed back toward the center of treatment container (18) and down toward bowl (66). Controller (22) operates to introduce treatment composition from one or both pre-mix containers (24, 46) by operation of pumps (38, 60) into the treatment space inside treatment container (18). Seed is then allowed to interact with the one or more treatment compositions for a pre-determined period. Optionally, dry powder may be dispensed from powder container (34) into the treatment space from powder conveyer (36) according to the program set in controller (22). A second pre-determined period is allowed to elapse to allow for coating of treated seed with the introduced powder. Controller (22) then directs opening of seed exit door (74) and treated seed is directed through collection hopper (20) to packaging equipment or other destinations as desired by the operator.

The embodiments above are intended to be illustrative and not limiting. Additional embodiments are within the claims. Although the present invention has been described with reference to particular embodiments, workers skilled in the art will recognize that changes may be made in form and detail without departing from the spirit and scope of the invention.

What is claimed is:

1. A modular seed treatment apparatus for applying fluids to seeds comprising:
a frame assembly;
a storage hopper assembly mounted to the frame assembly comprising a plurality of side walls operably coupled to define an interior space adapted to store untreated seeds;
at least one pre-mix container mounted to the frame assembly, the pre-mix container defining an interior storage region adapted to store a seed treatment fluid; and
an interchangeable treatment container mounted to the frame assembly comprising a body portion, a rotating bowl disposed within the body portion and a lid portion comprising a plurality of fins for directing seeds downwards and towards the center of the rotating bowl, the lid portion being reversibly secured to the body portion, wherein the interchangeable treatment container is operably coupled to the hopper to receive untreated seeds and to the pre-mix container to receive seed treatment fluid, and wherein the interchangeable treatment container can be removed from the frame assembly without disengaging the storage hopper assembly or pre-mix container from the frame assembly.

2. The modular seed treatment apparatus of claim 1 wherein the storage hopper assembly further comprises a scale operably coupled to the interior storage space to weigh untreated seeds.

3. The modular seed treatment apparatus of claim 2 wherein the storage hopper assembly further comprises a conveyance hopper operably coupled to the scale and to the interchangeable treatment container to direct the weighed untreated seeds from the scale into the interchangeable treatment container.

4. The modular seed treatment apparatus of claim 1 wherein the pre-mix container further comprises an agitation device for agitating the seed treatment fluid stored in the interior storage region.

5. The modular seed treatment apparatus of claim 1 further comprising a pump operably connected to the pre-mix container to convey fluid stored in the interior storage region of the pre-mix container to the interchangeable treatment container.

6. The modular seed treatment apparatus of claim 5 wherein the lid portion comprises a central opening.

7. The modular seed treatment apparatus of claim 6 further comprising an atomizer positioned within the central opening of the lid, wherein the atomizer is operably coupled to pump to receive the seed treatment fluid stored in the interior storage region.

8. The modular seed treatment apparatus of claim 1 wherein the plurality of fins are arranged on the lid in a symmetric arrangement.

9. The modular seed treatment apparatus of claim 1 wherein the plurality of fins are arranged on the lid in an asymmetric arrangement.

10. The modular seed treatment apparatus of claim 1 wherein the rotating bowl comprises a substantially flat surface near the center of rotation and angles upward from the substantially flat surface as the bowl approaches an inside wall of the interchangeable treatment container.

11. The modular seed treatment apparatus of claim 1 wherein the interchangeable treatment container is adapted to hold from about 0.5 to about 2 pounds of seeds.

12. The modular seed treatment apparatus of claim 1 wherein the interchangeable treatment container is adapted to hold from about 2 to about 5 pounds of seeds or from about 5 to about 10 pounds of seeds.

13. The modular seed treatment apparatus of claim 1 further comprising a powder storage container defining a powder storage region and powder conveyor operably connected to the powder storage container and to the interchangeable treatment container to deliver powder from powder storage container to the interchangeable treatment container, wherein the powder storage container and the powder conveyor are mounted to the frame assembly.

14. The modular seed treatment apparatus of claim 1 wherein the lid portion comprises 3 or 4 fins, and wherein the fins are reversibly attached to the lid portion so that configuration of the fins can be varied.

15. The modular seed treatment apparatus of claim 1 wherein the lid portion is flat and is composed of a transparent material.

16. The modular seed treatment apparatus of claim 1 further comprising a first pre-mix container and a second pre-mix container.

17. The modular seed treatment apparatus of claim 1 further comprising a controller operably coupled to the pre-mix container and to the storage hopper assembly to control the introduction the seed treatment fluid and untreated seeds into the interchangeable treatment container.

18. A method of applying fluid to a seed comprising:
operably coupling an interchangeable treatment container to a pre-mix container and to a storage hopper assembly, wherein the interchangeable treatment container comprises a body portion, a rotating bowl disposed within the body portion and a lid portion comprising a plurality of fins for directing seeds downwards and towards the center of the rotating bowl, the lid portion being reversibly secured to the body portion, wherein the pre-mix container and the storage hopper assembly are mounted to a frame assembly, and wherein the interchangeable treatment container can be coupled and uncoupled from the pre-mix container and the storage hopper assembly without disengaging the storage hopper assembly or the pre-mix container from the frame assembly.

19. The method of claim 18 further comprising selecting a desired interchangeable treatment container based on the batch size of the seeds.

20. The method of claim 18 further comprising introducing seeds from the storage hopper assembly and seed treatment fluid from the pre-mix container into the interchangeable treatment container.
